(19) United States
(12) Patent Application Publication
(10) Pub. No.: US 2016/0205136 A1
(43) Pub. Date: Jul. 14, 2016

(54) DATA COLLECTION

(71) Applicant: Danielle Davenport, San Martin, CA (US)

(72) Inventors: Danielle D. Davenport, San Martin, CA (US); Sanjiv Goyal, Cupertino, CA (US); Kalyanaraman Balakrishnan, Union City, CA (US); Cameron Lewis, Woodland, CA (US)

(73) Assignee: DIDEAN SYSTEMS, INC., Santa Clara, CA (US)

(21) Appl. No.: 14/596,107

(22) Filed: Jan. 13, 2015

(51) Int. Cl. H04L 29/06; H04L 29/08

(52) U.S. Cl. CPC H04L 63/20; H04L 63/10; H04L 67/306

(57) ABSTRACT

A method includes accessing user data corresponding to a user profile. The method may also include accessing at least one privacy setting corresponding to the user profile. The method may further include collecting, responsive to execution of an application by a portable electronic device based on the user data, data via the portable electronic device in accordance with the at least one privacy setting.

### BACKGROUND

Customer insight is valuable to businesses of all types. Information about the demographics, behaviors, and preferences of customers can improve the design, manufacture, marketing, distribution, and/or retailing of a product. It can also allow businesses to better reach and engage customers, thereby improving the customer experience and potentially increasing revenue.

Despite its importance, meaningful customer insight has become increasingly difficult to obtain in light of recent privacy concerns. It is often unclear what information is being collected by businesses and how the collected information is being used or shared. Additionally, data breaches and data theft are increasing.

Loyalty card programs are one example of a mechanism for providing customer insight. In exchange for discounts on products, loyalty cards allow retailers to collect information about consumer purchases. However, these programs suffer from a number of drawbacks related to data collection such as the ability for a consumer to avoid using the loyalty card for one or more purchases, the ability for a particular consumer to have multiple loyalty cards, and the ability for more than one consumer to share a particular loyalty card. Accordingly, the customer insight provided by loyalty card programs is limited and potentially misleading.

### SUMMARY

Accordingly, a need exists for providing improved customer insight. A need also exists for providing an increased amount of customer insight. Further, a need exists for providing more accurate and/or precise customer insight. Embodiments disclosed herein provide novel solutions to these needs and others as described below.

In one embodiment, a method includes accessing user data corresponding to a user profile. The method may also include accessing at least one privacy setting corresponding to the user profile. The method may further include collecting, responsive to execution of an application by a portable electronic device based on the user data, data via the portable electronic device in accordance with the at least one privacy setting.

In another embodiment, a system includes a database configured to store first data corresponding to a plurality of user profiles, wherein the first data includes user data corresponding to a user profile of the plurality of user profiles, and wherein the first data includes at least one privacy setting corresponding to the user profile. The system may also include a computer system configured to access, from the database, the user data and the at least one privacy setting, wherein the computer system is further configured to collect, responsive to execution of an application by a portable electronic device based on the user data, second data via the portable electronic device in accordance with the at least one privacy setting, and wherein the computer system is separate from the portable electronic device.

In yet another embodiment, a system includes means for accessing user data corresponding to a user profile. The system may also include means for accessing at least one privacy setting corresponding to the user profile. The system may further include means for collecting, responsive to execution of an application by a portable electronic device based on the user data, data via the portable electronic device in accordance with the at least one privacy setting.

### BRIEF DESCRIPTION OF THE DRAWINGS

The present invention is illustrated by way of example, and not by way of limitation, in the figures of the accompanying drawings and in which like reference numerals refer to the same or similar elements.

FIG. 1 shows a system in accordance with one embodiment.

FIG. 2 shows a database in accordance with one embodiment.

FIG. 3 shows a flowchart of a process for collecting data in accordance with one embodiment.

FIG. 4 shows a flowchart of a process for creating a user profile or account in accordance with one embodiment.

FIG. 5 shows a flowchart of a process for collecting other data in accordance with one embodiment.

FIG. 6 shows a flowchart of a process for sharing data in accordance with one embodiment.

FIG. 7 shows a flowchart of a process for performing at least one operation in accordance with one embodiment.

FIG. 8 shows a computer system upon which one or more embodiments may be implemented.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

### Notation and Nomenclature

Some regions of the detailed descriptions which follow are presented in terms of procedures, logic blocks, processing and other symbolic representations of operations on data bits within a computer memory. These descriptions and representations are the means used by those skilled in the art to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing the terms such as “aborting,” “accepting,” “accessing,” “activating,” “adding,” “adjusting,” “allocating,” “allowing,” “analyzing,” “applying,” “assembling,” “assigning,” “authenticating,” “authorizing,” “balancing,” “blocking,” “calculating,” “capturing,” “causing,” “changing,” “charging,” “combining,” “comparing,” “collecting,” “communicating,” “comparing,” “configuring,” “controlling,” “converting,” “correlating,” “creating,” “deactivating,” “debugging,” “decreasing,” “decrypting,” “defining,” “delivering,” “depicting,” “detecting,” “determining,” “discharging,” “displaying,” “downloading,” “enabling,” “encrypting,” “establishing,” “executing,” “forwarding,” “flipping,” “generating,” “grouping,” “hiding,” “identifying,” “ignoring,” “increasing,” “initiating,” “instantiating,” “interacting,” “measuring,” “modifying,” “monitoring,” “moving,” “outputting,” “parsing,” “performing,” “placing,” “presenting,” “processing,” “programming,” “providing,” “provisioning,” “querying,” “receiving,” “reformatting,” “regulating,” “removing,” “rendering,” “repeating,” “resuming,” “retaining,” “sampling,” “simulating,” “selecting,” “sending,” “sharing,” “sorting,” “storing,” “subtracting,” “suspending,” “tracking,” “transcoding,” “transforming,” “transmitting,” “unblocking,” “using,” “validating,” “verifying,” or the like, may refer to the action and/or processes of a computer system, or similar electronic computing device, that manipulates and transforms data represented as physical (electronic) quantities within the computer system's registers and memories into other data similarly represented as physical quantities within the computer system memories or registers or other such information storage, transmission and/or display devices.

### EMBODIMENTS

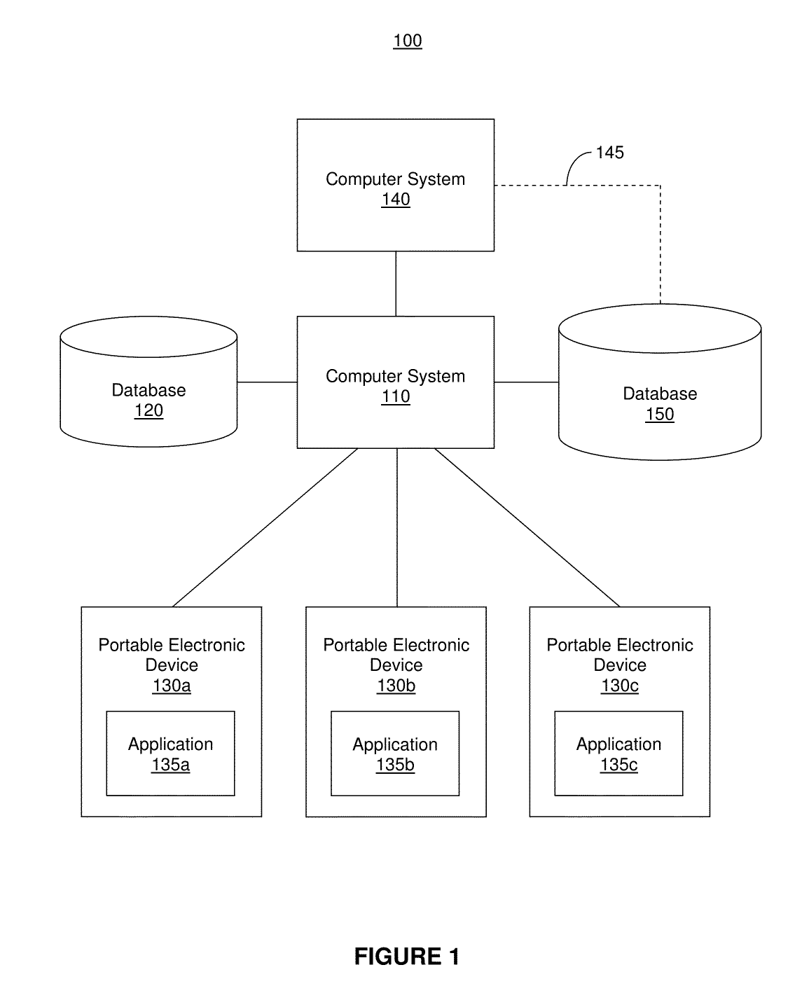

FIG. 1 shows system 100 in accordance with one embodiment. As shown in FIG. 1, one or more portable electronic devices (e.g., 130a, 130b, 130c, etc.) may be used to collect data associated with at least one user responsive to execution of at least one application (e.g., 135a, 135b, 135c, etc.) by the one or more portable electronic device (e.g., 130a, 130b, 130c, etc.). Execution of an application may be performed by a portable electronic device based on user data (e.g., supplied by a user of a portable electronic device, collected about the user via the portable electronic device, etc.), and data may be collected (e.g., by computer system 110) using the portable electronic device (e.g., during or as a result of execution of an application) in accordance with at least one privacy setting. The user data and the at least one privacy setting may be associated with a user profile or account in one embodiment.

Accordingly, system 100 may advantageously increase customer insight by allowing collection of a larger amount of data associated with a user. For example, more types of data may be collected utilizing one or more sensors or components of the portable electronic device (e.g., directly and/or via communication with at least one component separate from the portable electronic device), based on user interactions with the portable electronic device responsive to application execution, some combination thereof, etc. As another example, data may be collected for a longer duration (e.g., during an entire shopping trip or a portion thereof) as the portable electronic device is carried by or otherwise in proximity to a user. Further, where execution of an application (e.g., 135a, 135b, 135c, etc.) based on the user data provides a more engaging user experience (e.g., via customization or personalization of the application execution based on the user data, by “gamifying” the user experience, etc.), data collection may be increased as a result of longer application execution and/or a longer interaction between a user and the portable electronic device.

As shown in FIG. 1, each application (e.g., 135a, 135b, 135c, etc.) may be a tool, game, or other type of application. In one embodiment, where an application (e.g., 135a, 135b, 135c, etc.) is executed (e.g., by portable electronic device 130a, portable electronic device 130b, portable electronic device 130c, etc.) based on user data (e.g., to render content corresponding to the user data, perform processing related to the user data, etc.), the user data may be used to customize or personalize the application execution with respect to one or more attributes of a user (e.g., age, gender, appearance, etc.).

System 100 may also advantageously increase customer insight by increasing the accuracy and/or precision of the data collection. For example, where execution of an application (e.g., 135a, 135b, 135c, etc.) based on the user data provides a more engaging user experience (e.g., via customization or personalization of the application execution based on the user data, by “gamifying” the user experience, etc.), a user may be more likely to use the application and/or portable electronic device (e.g., when shopping where the application relates to shopping and/or collection of shopping-related data). As such, the accuracy and/or precision of the data collection may be increased by providing a more complete or representative picture of the behaviors and/or preferences of a user.

As another example, the collected data may be linked to and/or organized using one or more user profiles or accounts, where each user profile or account may correspond to a respective portable electronic device (e.g., 130a, 130b, 130c, etc.), a respective user, a respective group of users (e.g., a family, co-workers, a group of friends, etc.), or some combination thereof. In this manner, the accuracy and/or precision of the data collection may be increased by associating data collected (e.g., for a particular portable electronic device, a particular user, and/or a particular group of users) with a user profile.

In one embodiment, identification data (e.g., a name, an email address, a password, an authorization code from another computer system performing authentication of a user, a token from another computer system performing authentication of a user, some combination thereof, etc.) accessed via a portable electronic device (e.g., 130a, 130b, 130c, etc.) may allow authentication of a user of the portable electronic device and/or determination of a user profile associated with the user, thereby allowing proper association of collected data with a user profile and/or reducing unauthorized or unintentional use of a user profile. In this manner, the accuracy and/or precision of the data collection may be increased.

Data collection may be performed by or using computer system 110 in one embodiment. For example, user data (e.g., associated with a user profile) and at least one privacy setting (e.g., associated with the user profile) may be accessed at or by computer system 110 (e.g., from database 120). The user data (or a portion thereof) and/or the at least one privacy setting (or a portion thereof) may be supplied to a portable electronic device (e.g., 130a, 130b, 130c, etc.) for execution of an application (e.g., 135a, 135b, 135c, etc.). Responsive to execution of the application by the portable electronic device based on the user data, data may be collected via the portable electronic device in accordance with the at least one privacy setting. The collected data may be communicated from the portable electronic device to computer system 110 in one embodiment. And in one embodiment, the collected data may be stored in database 120.

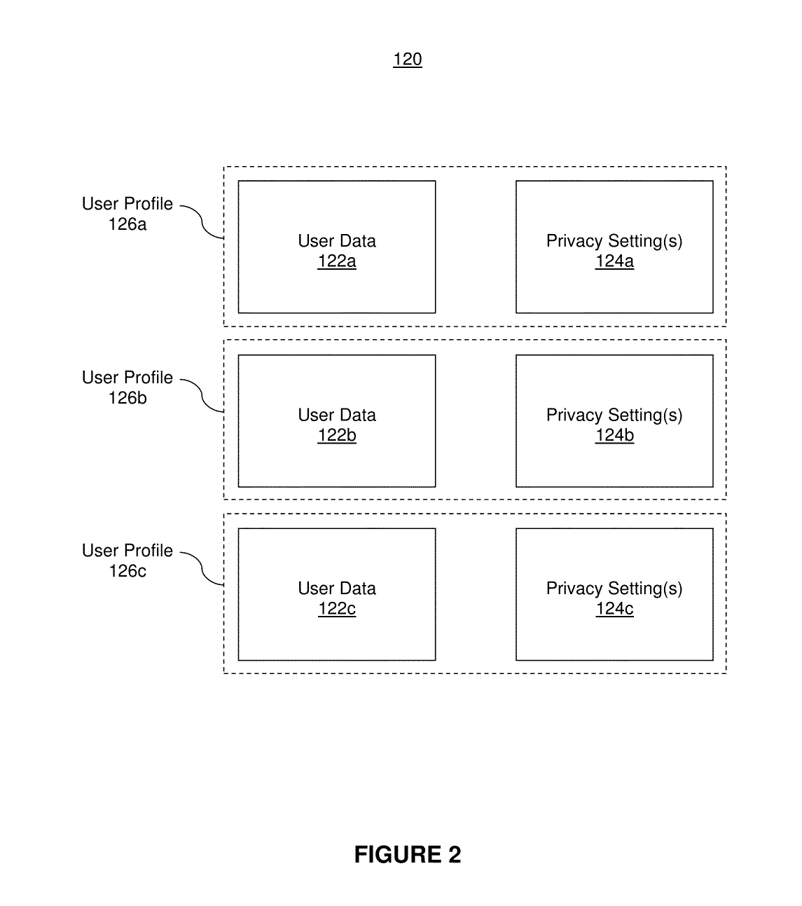

FIG. 2 shows database 120 in accordance with one embodiment. As shown in FIG. 2, database 120 may include user data (e.g., 122a, 122b, 122c, etc.) and at least one privacy setting (e.g., 124a, 124b, 124c, etc.). The data stored in database 120 (e.g., user data and/or at least one privacy setting) may be organized into and/or associated with user profiles or accounts (e.g., 126a, 126b, 126c, etc.), where each user profile or account may correspond to a respective portable electronic device (e.g., 130a, 130b, 130c, etc.), a respective user, a respective group of users (e.g., a family, co-workers, a group of friends, etc.), or some combination thereof. For example, user data 122a and at least one privacy setting 124a may correspond to user profile 126a, user data 122b and at least one privacy setting 124b may correspond to user profile 126b, and user data 122c and at least one privacy setting 124c may correspond to user profile 126c.

In one embodiment, at least one privacy setting (e.g., 124a, 124b, 124c, etc.) may be associated with data collection. For example, one or more privacy settings may allow or restrict the collection of certain types of data, the frequency or timing of the data collection, at least one other parameter of the data collection, etc. As another example, at least one privacy setting (e.g., 124a, 124b, 124c, etc.) may be used to configure data collection via a portable electronic device (e.g., 130a, 130b, 130c, etc.) by executing an application (e.g., 135a, 135b, 135c, etc.) on the portable electronic device in accordance with the at least one privacy setting.

At least one privacy setting (e.g., 124a, 124b, 124c, etc.) may be associated with data sharing in one embodiment. For example, one or more privacy settings may allow or restrict the sharing of certain types of data (e.g., user data, data stored in database 120, etc.) with computer system 140 (e.g., as shown in FIG. 1), other systems or devices, etc. Computer system 140 may be associated with a third party in one embodiment, where the third party may be an entity, individual, etc. other than an entity, individual, etc. associated with: computer system 110; portable electronic device 130a; portable electronic device 130b; portable electronic device 130c; some combination thereof; etc.

In one embodiment, at least one privacy setting (e.g., 124a, 124b, 124c, etc.) may be set or modified by a user (e.g., associated with the user profile corresponding to the at least one privacy setting). The at least one privacy setting may be set or modified before execution of an application (e.g., in accordance with the at least one privacy setting), during execution of the application, etc. The at least one privacy setting may be set or modified using the portable electronic device (e.g., 130a, 130b, 130c, etc.) used to collect data (e.g., in accordance with at least one privacy setting), another computer system, etc. Accordingly, system 100 may advantageously allow users to control data collection and/or data sharing, where providing increased control over data collection and/or data sharing may result in increased trust and loyalty from customers, increased supply of user data from customers, increased customer interaction with a portable electronic device (e.g., 130a, 130b, 130c, etc.) and/or an application (e.g., 135a, 135b, 135c, etc.) which may in turn allow increased data collection, etc.

One or more privacy settings of the at least one privacy setting (e.g., 124a, 124b, 124c, etc.) may be selected from a range or plurality of options (e.g., values, levels, settings, etc.) in one embodiment. For example, a user interface may present a range or plurality of options for controlling collection of data related to location, where each option corresponds to a different level or granularity of data collection related to location (e.g., whether a portable electronic device is detected within a particular city, within a particular store, within a particular region of a store, near a particular product within a store, etc.). As another example, a user interface may present a range or plurality of options for controlling sharing of user data, where each option corresponds to a different privacy or sensitivity level (e.g., less-sensitive data such as age or gender, more-sensitive data such as income, employer, health issues, weight, physical measurements, etc.). In this manner, control over data collection and/or data sharing may be increased.

User data (e.g., 122a, 122b, 122c, etc.) may include information supplied by a user of a portable electronic device (e.g., 130a, 130b, 130c, etc.) in one embodiment. For example, user data (e.g., 122a, 122b, 122c, etc.) may include personal information (e.g., an age, gender, etc.), at least one image (e.g., of a user associated with a user profile), a fiscal budget (e.g., of a user associated with a user profile), a frequency of past shopping trips, at least one brand preference, some combination thereof, etc. As another example, user data (e.g., 122a, 122b, 122c, etc.) may include application-specific data (e.g., corresponding to application 135a, application 135b, application 135c, etc.) supplied by a user such as information corresponding to at least one shopping list item (e.g., in the case of an application related to retail shopping or another type of shopping), information corresponding to at least one product (e.g., in the case of an application related to shopping for at least one product), at least one physical measurement of a user associated with a user profile (e.g., in the case of an application related to clothes shopping), etc. As yet another example, user data (e.g., 122a, 122b, 122c, etc.) may include information corresponding to at least one purchased item, where the at least one purchased item may be a product or item purchased using an application (e.g., 135a, 135b, 135c, etc.) of a portable electronic device (e.g., 130a, 130b, 130c, etc.), a product or item registered using an application (e.g., 135a, 135b, 135c, etc.) of a portable electronic device (e.g., 130a, 130b, 130c, etc.), some combination thereof, etc.

User data (e.g., 122a, 122b, 122c, etc.) may include data collected via a portable electronic device (e.g., 130a, 130b, 130c, etc.) in one embodiment. For example, user data may include data collected utilizing one or more sensors or components of a portable electronic device, where the collected data may include at least one location (e.g., an absolute location of the portable electronic device, a relative location of the portable electronic device with respect to a store, a relative location of the portable electronic device with respect to a region of a store such as an aisle, a relative location of the portable electronic device with respect to a product in a store, etc.), at least one image (e.g., taken using a camera or other imaging component of the portable electronic device) of an item or code (e.g., barcode, QR code, etc.) of an item, information associated with at least one image (e.g., taken using a camera or other imaging component of the portable electronic device), etc. Where the collected data includes information associated with at least one image, the information may include product information (e.g., a name, brand, model, size, color, etc.) associated with at least one item or item code in the at least one image.

In one embodiment, user data may include data collected directly utilizing one or more sensors or components of a portable electronic device. For example, a location (e.g., of the portable electronic device) may be determined directly using a global positioning system (GPS) receiver of the portable electronic device. And in one embodiment, user data may include data collected via communication with at least one component separate from the portable electronic device. For example, a location (e.g., of the portable electronic device) may be determined via communication between the portable electronic device and at least one component such as at least one beacon, at least one radio-frequency identification (RFID) tag, Wi-Fi components allowing Wi-Fi triangulation, at least one component allowing near field communication (NFC), etc.

As another example, user data may include collected data associated with one or more interactions between the user and the portable electronic device responsive to application execution. At least one interaction may involve entry or input of text or other information via the portable electronic device, selection of one or more graphical elements displayed on a display device of the portable electronic device, rendering of content (e.g., at least one image, video, audio, etc.) corresponding to the application, etc. Where execution of the application is configured to implement an augmented reality shopping experience, the user data may include content (or information associated with the content) rendered as part of the augmented reality shopping experience (e.g., content or information associated with at least one product or item, nutritional information, historical information, price comparison information, etc.), information associated with at least one user interaction related to the augmented reality shopping experience (e.g., a list of items selected by a user, information about how a user changed the view or display of a virtual item, etc.), etc.

As yet another example, user data may include data collected at a plurality of times, where the collected data may be (or be used to generate) behavioral data, historical data, etc. The user data may include data collected utilizing one or more sensors or components of a portable electronic device at a plurality of times (e.g., a user's location at multiple times during a shopping trip, etc.), data associated with interactions at a plurality of times between the user and the portable electronic device responsive to application execution (e.g., items or products scanned or photographed by a user over the course of a shopping trip, a user's viewing or selection history related to an augmented reality shopping experience, information about how a user changed the view or display of a virtual item over time related to an augmented reality shopping experience, etc.), other data collected at a plurality of times, etc.

In one embodiment, user data may include registration data. Registration data may be any information collected and/or shared with a product manufacturer to register a product (e.g., to provide or allow warranty, support, returns, rebate, recall, etc.). For example, registration data may include information associated with a user (e.g., name, mailing address, demographic information, etc.), information associated with a product (e.g., model number, serial number, purchase date, purchase store or location, image of the product, image of a code of the product, image of a serial number and/or model number of the product, etc.), information associated with at least one product manufacturer (e.g., corresponding to the registration of one or more products), etc.

Although FIG. 2 shows database 120 with a specific type and amount of data, it should be appreciated that database 120 may include a different type and/or amount of data in other embodiments. For example, database 120 may include a different quantity of user data portions (e.g., similar to user data 122a, user data 122b, user data 122c, etc.), privacy setting portions (e.g., similar to at least one privacy setting 124a, at least one privacy setting 124b, at least one privacy setting 124c, etc.), user profile portions (e.g., similar to user profile 126a, user profile 126b, user profile 126c, etc.), some combination thereof, etc. As another example, database 120 may include additional types of data (e.g., which may or may not be associated with a user profile), fewer types of data (e.g., only user data, only at least one privacy setting, etc.), etc. And although FIG. 2 shows database 120 with a specific arrangement of data, it should be appreciated that database 120 may include a different arrangement of data in other embodiments.

Turning back to FIG. 1, database 150 may store information such as incentive data, advertisement data, loyalty card data, other data, some combination thereof, etc. Incentive data may correspond to at least one coupon, at least one discount, at least one point, at least one frequent flyer mile, cash back, some combination thereof, etc. Loyalty card data may include information associated with a user's purchase history at a retailer, where the information may correspond to a loyalty card program run by or associated with the retailer. Database 150 may be associated with a third party in one embodiment, where the third party may be an entity, individual, etc. other than an entity, individual, etc. associated with: computer system 110; portable electronic device 130a; portable electronic device 130b; portable electronic device 130c; some combination thereof; etc.

Where database 150 stores incentive data, the incentive data may be accessed and provided to a portable electronic device (e.g., 130a, 130b, 130c, etc.) responsive to execution of an application (e.g., 135a, 135b, 135c, etc.) by the portable electronic device. The incentive data may be provided to the portable electronic device by computer system 110, where computer system 110 may access the incentive data directly from database 150 or via computer system 140 (e.g., which accesses the incentive data via connection 145). Computer system 140 may be associated with a third party (e.g., a consumer product goods manufacturer, a retailer, an independent incentive processing company, a website or online server providing incentive data, etc.) which is also associated with database 150 in one embodiment.

Where database 150 stores advertisement data, the advertisement data may be accessed and provided to a portable electronic device (e.g., 130a, 130b, 130c, etc.) responsive to execution of an application (e.g., 135a, 135b, 135c, etc.) by the portable electronic device. The advertisement data may be provided to the portable electronic device by computer system 110, where computer system 110 may access the advertisement data directly from database 150 or via computer system 140 (e.g., which accesses the advertisement data via connection 145). Computer system 140 may be associated with a third party (e.g., a consumer product goods manufacturer, a retailer, an independent advertisement processing company, a website or online server providing advertisement data, etc.) which is also associated with database 150 in one embodiment.

Accordingly, database 150 may advantageously be used to provide more relevant information to customers (e.g., based on user data supplied by a user, collected about a user, etc.). For example, where a customer has previously purchased a particular item or particular brand of item (e.g., determined based on user data associated with past purchases), data (e.g., incentive data, advertisement data, etc.) corresponding to the particular item or particular brand of item may be provided to a portable electronic device that is associated with, used by, owned by, etc. the customer. As another example, where a customer is located near a particular item in a store (e.g., as determined using a sensor or component of a portable electronic device that is associated with, used by, owned by, etc. the customer), data (e.g., incentive data, advertisement data, etc.) corresponding to the particular item or brand of item may be provided to the portable electronic device.

Database 150 may advantageously be used to reward customers for certain behaviors. For example, where a user sets or modifies at least one privacy setting (e.g., 124a, 124b, 124c, etc.) to allow or increase collection and/or sharing of user data (e.g., 122a, 122b, 122c, etc.), incentive data may be provided to the user (e.g., via a portable electronic device that is associated with, used by, owned by, etc. the user, posted to a user profile or account associated with the user, etc.) as a reward.

In one embodiment, where database 150 stores loyalty card data, the loyalty card data may be accessed by computer system 110. Computer system 110 may access the loyalty card data directly from database 150 or via computer system 140 (e.g., which accesses the loyalty card data via connection 145). Computer system 140 may be associated with a third party (e.g., a consumer product goods manufacturer, a retailer, an independent loyalty card processing company, etc.) which is also associated with database 150 in one embodiment.

Loyalty card data accessed by computer system 110 may be stored in database 120 in one embodiment. The loyalty card data may be stored in database 120 in accordance with at least one user profile (e.g., associated with the user corresponding to an account associated with the loyalty card data). For example, the loyalty card data may be organized into and/or associated with a user profile (e.g., 126a, 126b, 126c, etc.). The loyalty card data may be organized and/or associated with other data (e.g., user data, at least one privacy setting, etc.) corresponding to the user profile in one embodiment.

Computer system 110 may use the loyalty card data to increase customer insight. For example, the loyalty card data may be combined with user data (e.g., 122a, 122b, 122c, etc.) to provide more information about a customer. As another example, analysis may be performed using the loyalty card data and user data (e.g., 122a, 122b, 122c, etc.) to determine other information such as purchasing trends or behaviors for a single customer (e.g., with one or more attributes determined based on or identified by user data), purchasing trends or behaviors across multiple customers (e.g., with one or more attributes determined based on or identified by user data), other data, etc.

In one embodiment, where database 150 stores loyalty card data, at least a portion of user data (e.g., 122a, 122b, 122c, etc.) may be shared with a third party (e.g., associated with database 150, computer system 140, some combination thereof, etc.) in accordance with at least one privacy setting (e.g., 124a, 124b, 124c, etc.). For example, if a user has set or modified at least one privacy setting to allow sharing of user data (e.g., only user-supplied data, only user-supplied data of a certain type, only collected data, only collected data of a certain type, both user-supplied data and collected data, etc.) with a third party, at least a portion of user data (e.g., associated with a user profile or account corresponding to the user) may be shared with the third party to provide more information about the user. As such, where the third party is a retailer, the portion of user data may be used by the retailer to improve product offerings, product placement within stores, promotions, incentives, the customer experience with respect to the retailer or affiliates of the retailer, etc.

As shown in FIG. 1, each portable electronic device (e.g., 130a, 130b, 130c, etc.) may be a general-purpose computer system, an embedded computer system, a laptop computer system, a hand-held computer system, a portable computer system, a wearable device or wearable computer system, a stand-alone computer system, a server, etc. In one embodiment, portable electronic devices (e.g., 130a, 130b, 130c, etc.) may communicate with one another and/or computer system 110 via the Internet and/or one or more intermediary systems, intermediary devices, networks, etc.

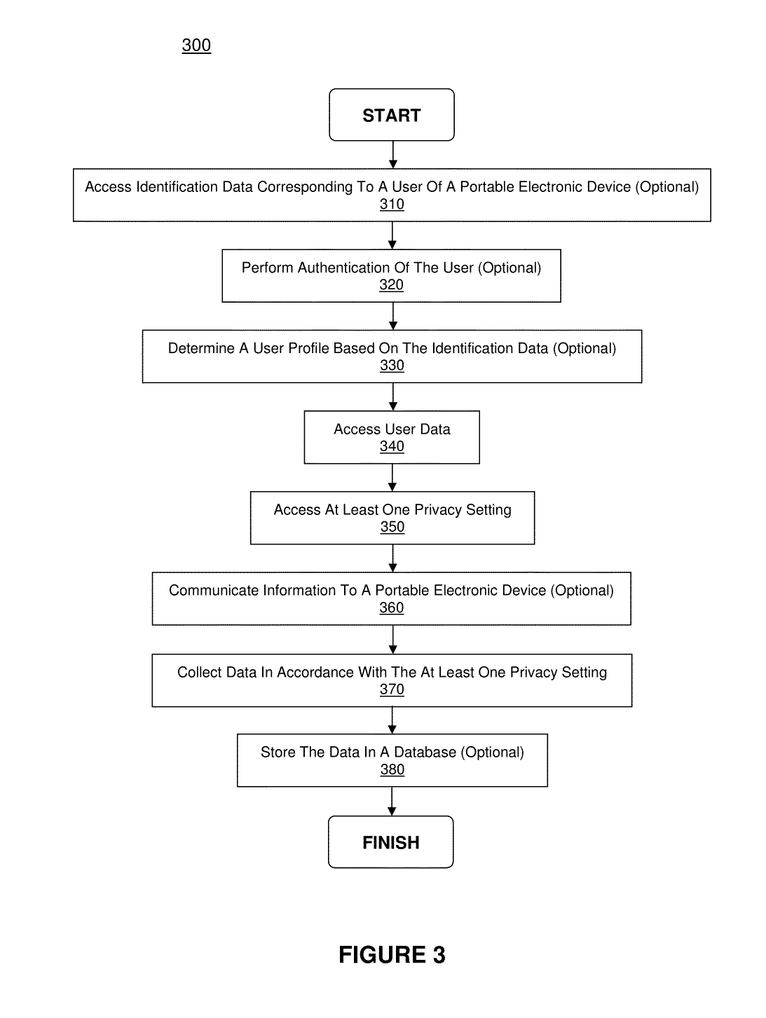

FIG. 3 shows a flowchart of process 300 for collecting data in accordance with one embodiment. As shown in FIG. 3, step 310 involves optionally accessing identification data corresponding to a user of a portable electronic device (e.g., 130a, 130b, 130c, etc.). The identification data accessed in step 310 may include a name, an email address, a password, an authorization code from another computer system (e.g., 140) performing authentication of a user, a token from another computer system (e.g., 140) performing authentication of a user, some combination thereof, etc.

The identification data may be accessed via the portable electronic device in one embodiment. In one embodiment, the identification data may be accessed via another computer system (e.g., other than the portable electronic device such as computer system 140). And in one embodiment, step 310 may involve accessing the identification data at computer system 110.

As shown in FIG. 3, step 320 involves optionally performing authentication of the user (e.g., of the portable electronic device). Step 320 may involve performing authentication of the user based on the identification data accessed in step 310. Authentication of the user may be performed in step 320 at computer system 110 in one embodiment. And in one embodiment, authentication of the user may be performed in step 320 at another computer system (e.g., other than the computer system 110 such as computer system 140).

Step 330 involves optionally determining a user profile based on the identification data (e.g., accessed in step 310). The user profile or account determined in step 330 may be a user profile (e.g., 126a, 126b, 126c, etc.) corresponding to user data (e.g., 122a, 122b, 122c, etc.) and/or at least one privacy setting (e.g., 124a, 124b, 124c, etc.). Step 330 may be performed at computer system 110 in one embodiment.

As shown in FIG. 3, step 340 involves accessing user data (e.g., 122a, 122b, 122c, etc.). Step 340 may involve accessing user data at computer system 110 in one embodiment. In one embodiment, step 340 may involve accessing user data based on the identification data accessed in step 310. And in one embodiment, step 340 may involve accessing user data associated with the user profile or account determined in step 330. For example, where a particular user profile (e.g., 126a) is determined in step 330, step 340 may involve accessing particular user data (e.g., 122a) associated with the particular user profile.

Step 350 involves accessing at least one privacy setting (e.g., 124a, 124b, 124c, etc.). Step 350 may involve accessing at least one privacy setting at computer system 110 in one embodiment. In one embodiment, step 350 may involve accessing at least one privacy setting based on the identification data accessed in step 310. And in one embodiment, step 350 may involve accessing at least one privacy setting corresponding to the user profile or account determined in step 330. For example, where a particular user profile (e.g., 126a) is determined in step 330, step 350 may involve accessing one or more particular privacy settings (e.g., 124a) based on the particular user profile.

As shown in FIG. 3, step 360 involves optionally communicating information to a portable electronic device (e.g., 130a, 130b, 130c, etc.). In one embodiment, the information communicated in step 360 may be at least a portion of the user data (e.g., accessed in step 340) and/or data corresponding to at least a portion of the user data (e.g., accessed in step 340). And in one embodiment, the information communicated in step 360 may be at least a portion of at least one privacy setting (e.g., accessed in step 350) and/or data corresponding to at least a portion of at least one privacy setting (e.g., accessed in step 350).

In one embodiment, processing may be optionally performed on the user data (e.g., accessed in step 340) and/or at least one privacy setting (e.g., accessed in step 350). The processing may change the format or programming language of the information (e.g., to align it with a format or programming language that is understandable by the application and/or portable electronic device), encrypt and/or decrypt the data to increase security, redact one or more portions of the information to increase privacy and/or conform with privacy rules or regulations (e.g., HIPAA), etc. The processing may be performed at computer system 110 (e.g., before communication of the information in step 360 where step 360 is performed), at a portable electronic device (e.g., after communication of the information in step 360 where step 360 is performed), some combination thereof, etc.

Step 370 involves collecting data in accordance with at least one privacy setting (e.g., accessed in step 350, communicated in step 360, etc.). In one embodiment, the data may be collected in step 370 responsive to execution of an application (e.g., 135a, 135b, 135c, etc.) by a portable electronic device (e.g., 130a, 130b, 130c, etc.) based on user data (e.g., accessed in step 340, communicated in step 360, etc.). In one embodiment, step 370 may be performed by computer system 110, the portable electronic device (e.g., executing the application), some combination thereof, etc.

In one embodiment, collection of data in step 370 may be performed utilizing one or more sensors or components of a portable electronic device, where the collected data may include at least one location (e.g., an absolute location of the portable electronic device, a relative location of the portable electronic device with respect to a store, a relative location of the portable electronic device with respect to a region of a store such as an aisle, a relative location of the portable electronic device with respect to a product in a store, etc.), at least one image (e.g., taken using a camera or other imaging component of the portable electronic device) of an item or code (e.g., barcode, QR code, etc.) of an item, information associated with at least one image (e.g., taken using a camera or other imaging component of the portable electronic device), etc. Where the collected data includes information associated with at least one image, the information may include product information (e.g., a name, brand, model, size, color, etc.) associated with at least one item or item code in the at least one image.

Data may be collected (e.g., in step 370) directly utilizing one or more sensors or components of a portable electronic device (e.g., 130a, 130b, 130c, etc.) in one embodiment. For example, a location (e.g., of the portable electronic device) may be determined directly using a global positioning system (GPS) receiver of the portable electronic device. And in one embodiment, data may be collected (e.g., in step 370) via communication with at least one component separate from the portable electronic device. For example, a location (e.g., of the portable electronic device) may be determined via communication between the portable electronic device and at least one component (e.g., separate from the portable electronic device) such as at least one beacon, at least one RFID tag, Wi-Fi components allowing Wi-Fi triangulation, at least one component allowing NFC, etc.

In one embodiment, step 370 may involve collection of data associated with one or more interactions between the user and the portable electronic device responsive to application execution. At least one interaction may involve entry or input of text or other information via the portable electronic device, selection of one or more graphical elements displayed on a display device of the portable electronic device, rendering of content (e.g., at least one image, video, audio, etc.) corresponding to the application, etc. Where execution of the application is configured to implement an augmented reality shopping experience, data collected in step 370 may include content (or information associated with the content) rendered as part of the augmented reality shopping experience (e.g., content or information associated with at least one product or item, nutritional information, historical information, price comparison information, etc.), information associated with at least one user interaction related to the augmented reality shopping experience (e.g., a list of items selected by a user, information about how a user changed the view or display of a virtual item, etc.), etc.

Data may be collected (e.g., in step 370) at a plurality of times in one embodiment, where the collected data may be (or be used to generate) behavioral data, historical data, etc. The collected data may include data collected utilizing one or more sensors or components of a portable electronic device at a plurality of times (e.g., a user's location at multiple times during a shopping trip, etc.), data associated with interactions at a plurality of times between the user and the portable electronic device responsive to application execution (e.g., items or products scanned or photographed by a user over the course of a shopping trip, a user's viewing or selection history related to an augmented reality shopping experience, information about how a user changed the view or display of a virtual item over time related to an augmented reality shopping experience, etc.), other data collected at a plurality of times, etc.

As shown in FIG. 3, step 380 involves optionally storing the data (e.g., collected in step 370) in a database (e.g., 120). The data may be stored in the database (e.g., 120) as a portion of user data (e.g., 122a, 122b, 122c, etc.) in one embodiment. The data stored in step 380 may be organized into and/or associated with user profiles or accounts (e.g., 126a, 126b, 126c, etc.), where each user profile or account may correspond to a respective portable electronic device (e.g., 130a, 130b, 130c, etc.), a respective user, a respective group of users (e.g., a family, co-workers, a group of friends, etc.), or some combination thereof. In one embodiment, step 380 may be performed by computer system 110, the portable electronic device (e.g., executing the application and/or used to collect the data in step 370), some combination thereof, etc.

As a first example, process 300 (or one or more steps thereof) may allow collection of data related to retail shopping. Identification data associated with a user of a portable electronic device (e.g., 130a, 130b, 130c, etc.) may be accessed (e.g., in step 310). In one embodiment, the identification data may be accessed via the application and/or portable electronic device (e.g., where the user enters the identification information using the application and/or portable electronic device), via another computer system, etc. The identification data may be used to authenticate the user (e.g., in step 320) and/or determine a user profile (e.g., 126a, 126b, 126c, etc.) corresponding to the user (e.g., in step 330) in one embodiment.

In one embodiment, the user may be prompted to download the application (e.g., 135a, 135b, 135c, etc.) to the portable electronic device, where such prompting is performed by way of a push message or notification communicated to the portable electronic device, via a message displayed within a retail store, etc. Alternatively, the application may be pre-loaded on the portable electronic device (e.g., where the portable electronic device is provided by a retailer for use in a retail store).

In accordance with the first example, user data (e.g., 122a, 122b, 122c, etc.) including a shopping list and/or other information (e.g., previously-collected data associated with retail shopping, personal information such as age or gender, an image of the user, a fiscal budget for one or more shopping trips, a frequency of past shopping trips, at least one brand preference, etc.) may be accessed (e.g., in step 340). At least one privacy setting (e.g., 124a, 124b, 124c, etc.) may be accessed (e.g., in step 350), where the at least one privacy setting may be associated with data collection and/or data sharing.

The at least one privacy setting may be related to collection of data such as the location or proximity of the user while in the retail store, an image of an item or code (e.g., barcode, QR code, etc.) of an item, data collected based on interactions between the user and the portable electronic device responsive to application execution (e.g., presentation of information about an item in the retail store, selection or viewing of a product or information about the product, removing an item from a shopping list, adding an item to a shopping list, presentation of a recipe that includes an item on a shopping list, etc.), data collected at a plurality of times (e.g., a user's location in the retail store over time, information about products that were scanned or photographed in the retail store over time, etc.), etc. The at least one privacy setting may be related to sharing of data with a third party (e.g., a retailer, a consumer product goods manufacturer, etc.), where the shared data may include collected data and/or user data supplied by a user (e.g., personal information such as age or gender, an image of the user, a fiscal budget for one or more shopping trips, a frequency of past shopping trips, at least one brand preference, etc.).

Data related to retail shopping may be collected (e.g., in step 370) responsive to execution of the application by the portable electronic device based on the user data. For example, the application may be a game designed for children (e.g., where a portion of the user data supplied by the user includes information about one or more children such as age, gender, etc.) which presents educational information (e.g., in an age-appropriate format or using age-appropriate content) related to a scanned or photographed item, an item on the shopping list (e.g., provided as part of the user data), an item near the user (e.g., as determined based on the user's location in the retail store and/or the user's proximity to the item), etc. As another example, the application may present challenges or tasks for the user (e.g., to scan one or more items from the shopping list, to walk by a certain location in the retail store, etc.), thereby gamifying the shopping experience. By engaging the user via gamification in these examples, application execution time can be increased to increase the amount of data that can be collected via the portable electronic device (e.g., as the user moves through the retail store).

As a second example, process 300 (or one or more steps thereof) may allow collection of data related to clothes shopping. Identification data associated with a user of a portable electronic device (e.g., 130a, 130b, 130c, etc.) may be accessed (e.g., in step 310). In one embodiment, the identification data may be accessed via the application and/or portable electronic device (e.g., where the user enters the identification information using the application and/or portable electronic device), via another computer system, etc. The identification data may be used to authenticate the user (e.g., in step 320) and/or determine a user profile (e.g., 126a, 126b, 126c, etc.) corresponding to the user (e.g., in step 330) in one embodiment.

In one embodiment, the user may be prompted to download the application (e.g., 135a, 135b, 135c, etc.) to the portable electronic device, where such prompting is performed by way of a push message or notification communicated to the portable electronic device, via a message displayed within a clothing store, etc. Alternatively, the application may be pre-loaded on the portable electronic device (e.g., where the portable electronic device is provided by a retailer for use in a clothing store).

In accordance with the second example, user data (e.g., 122a, 122b, 122c, etc.) including a shopping list and/or other information (e.g., previously-collected data associated with clothes shopping, personal information such as age or gender, an image of the user, at least one physical measurement of the user, at least one image of a clothing item, a fiscal budget for one or more shopping trips, a frequency of past shopping trips, at least one brand preference, at least one favorite color of the user, etc.) may be accessed (e.g., in step 340). At least one privacy setting (e.g., 124a, 124b, 124c, etc.) may be accessed (e.g., in step 350), where the at least one privacy setting may be associated with data collection and/or data sharing.

The at least one privacy setting may be related to collection of data such as the location or proximity of the user while in the clothing store, an image of an item or code (e.g., barcode, QR code, etc.) of an item, data collected based on interactions between the user and the portable electronic device responsive to application execution (e.g., presentation of information about an item in the clothing store, selection or viewing of an item or information about the item, removing an item from a shopping list, adding an item to a shopping list, presentation of an image of the user dressed in a piece of clothing or outfit, etc.), data collected at a plurality of times (e.g., a user's location in the clothing store over time, information about products that were scanned or photographed in the clothing store over time, etc.), etc. The at least one privacy setting may be related to sharing of data with a third party (e.g., a retailer, a clothing manufacturer, etc.), where the shared data may include collected data and/or user data supplied by a user (e.g., personal information such as age or gender, an image of the user, a fiscal budget for one or more shopping trips, a frequency of past shopping trips, at least one brand preference, at least one favorite pattern of the user, at least one favorite color of the user, etc.).

Data related to clothes shopping may be collected (e.g., in step 370) responsive to execution of the application by the portable electronic device based on the user data. For example, the application may be a game designed for teenagers (e.g., where a portion of the user data supplied by the user includes information about one or more teenagers such as age, gender, etc.) which presents images of a user dressed in an item that is selected by a user, photographed by a user (e.g., using a camera or imaging device of the portable electronic device), scanned by a user (e.g., using a camera or imaging device of the portable electronic device), similar to or matches an item on the shopping list (e.g., provided as part of the user data), similar to or matches an item near the user (e.g., as determined based on the user's location in the clothing store and/or the user's proximity to the item), is popular or trendy at the time, etc. As another example, the application may present challenges or options for the user (e.g., to pick the outfit having the lowest price from a plurality of outfits, to see how an outfit would look on the user by presenting an image of the user dressed in the outfit, etc.), thereby gamifying the shopping experience. By engaging the user via gamification in these examples, application execution time can be increased to increase the amount of data that can be collected via the portable electronic device (e.g., as the user moves through the clothing store).

As a third example, execution of an application (e.g., 135a, 135b, 135c, etc.) by a portable electronic device (e.g., 130a, 130b, 130c, etc.) may implement an augmented reality shopping experience, where data may be collected (e.g., in step 370) associated with the augmented reality shopping experience. The application may present content (e.g., at least one image, video, sounds, etc.) or information (e.g., nutritional information, historical information, price comparison information, measurements, where to locate the item, etc.) associated with one or more items. The application may allow a user to interact with a virtual item similar to interaction with an actual item in a store (e.g., by zooming in on a portion of the virtual item to simulate looking more closely at a portion of an actual item, by altering the display of the virtual item to simulate turning or tilting the actual item, etc.). As such, the collected data may include content (or information associated with the content) rendered as part of the augmented reality shopping experience (e.g., content or information associated with at least one product or item, nutritional information, historical information, price comparison information, etc.), information associated with at least one user interaction related to the augmented reality shopping experience (e.g., a list of items selected by a user, information about how a user changed the view or display of a virtual item, etc.), etc.

The augmented reality shopping experience provided by the application (e.g., in accordance with the third example) may supplement or relate to an actual shopping experience (e.g., related to the first example and/or second example) in one embodiment. For example, an augmented reality shopping experience associated with a virtual item may be launched or initiated (e.g., using the application) responsive to detecting that a user is in proximity to (e.g., within a predetermined distance from) an actual item (e.g., related or corresponding to the virtual item) in a store, thereby enhancing the user experience, allowing the collection of a larger amount of data, increasing the accuracy and/or precision of the data collection, some combination thereof, etc.

Although FIG. 3 depicts process 300 as including a specific number of steps, it should be appreciated that process 300 may include a different number of steps in other embodiments. Although FIG. 3 depicts process 300 as including a specific ordering of steps, it should be appreciated that process 300 may include a different ordering of steps in other embodiments.

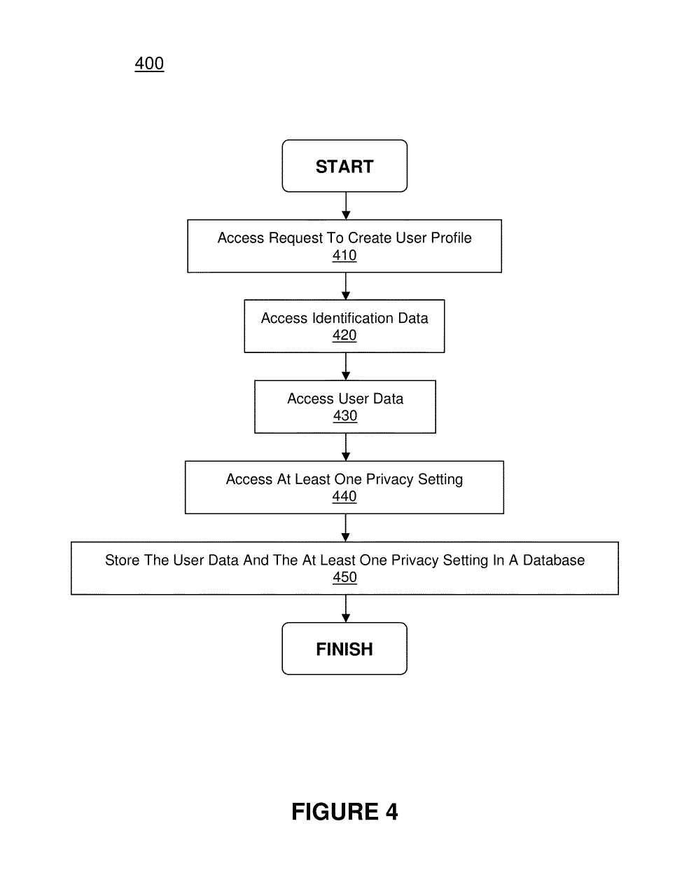

FIG. 4 shows a flowchart of process 400 for creating a user profile or account in accordance with one embodiment. As shown in FIG. 4, step 410 involves accessing a request to create a user profile (e.g., 126a, 126b, 126c, etc.). In one embodiment, the request may be received in step 410 at computer system 110. In one embodiment, the request may be input via, generated using, and/or communicated from a portable electronic device (e.g., 130a, 130b, 130c, etc.). And in one embodiment, the request may be input via, generated using, and/or communicated from another computer system (e.g., separate from portable electronic device 130a, portable electronic device 130b, portable electronic device 130c, etc.).

Step 420 involves accessing identification data. In one embodiment, the identification data accessed in step 420 may be the same identification data accessed in step 310 of process 300. The identification data may be subsequently used to associate a user (e.g., of a portable electronic device) with the user profile, authenticate the user, etc.

In one embodiment, the identification data may be received in step 420 at computer system 110. In one embodiment, the identification data may be input via, generated using, and/or communicated from a portable electronic device (e.g., 130a, 130b, 130c, etc.). And in one embodiment, the identification data may be input via, generated using, and/or communicated from another computer system (e.g., separate from portable electronic device 130a, portable electronic device 130b, portable electronic device 130c, etc.).

As shown in FIG. 4, step 430 involves accessing user data. In one embodiment, the user data accessed in step 430 may be the same user data accessed in step 340 of process 300 (or a portion thereof).

In one embodiment, the user data may be received in step 430 at computer system 110. In one embodiment, the user data may be input via, generated using, and/or communicated from a portable electronic device (e.g., 130a, 130b, 130c, etc.). And in one embodiment, the user data may be input via, generated using, and/or communicated from another computer system (e.g., separate from portable electronic device 130a, portable electronic device 130b, portable electronic device 130c, etc.).

As shown in FIG. 4, step 440 involves accessing at least one privacy setting. In one embodiment, the at least one privacy setting accessed in step 440 may be the same at least one privacy setting accessed in step 350 of process 300 (or a portion thereof).

In one embodiment, the at least one privacy setting may be received in step 440 at computer system 110. In one embodiment, the at least one privacy setting may be input via, generated using, and/or communicated from a portable electronic device (e.g., 130a, 130b, 130c, etc.). And in one embodiment, the at least one privacy setting may be input via, generated using, and/or communicated from another computer system (e.g., separate from portable electronic device 130a, portable electronic device 130b, portable electronic device 130c, etc.).

As shown in FIG. 4, step 450 involves storing the user data (e.g., accessed in step 430) and the at least one privacy setting (e.g., accessed in step 440) in a database (e.g., 120). In one embodiment, step 450 may involve storing the user data and the at least one privacy setting such that it is organized into and/or associated with the corresponding user profile or account.

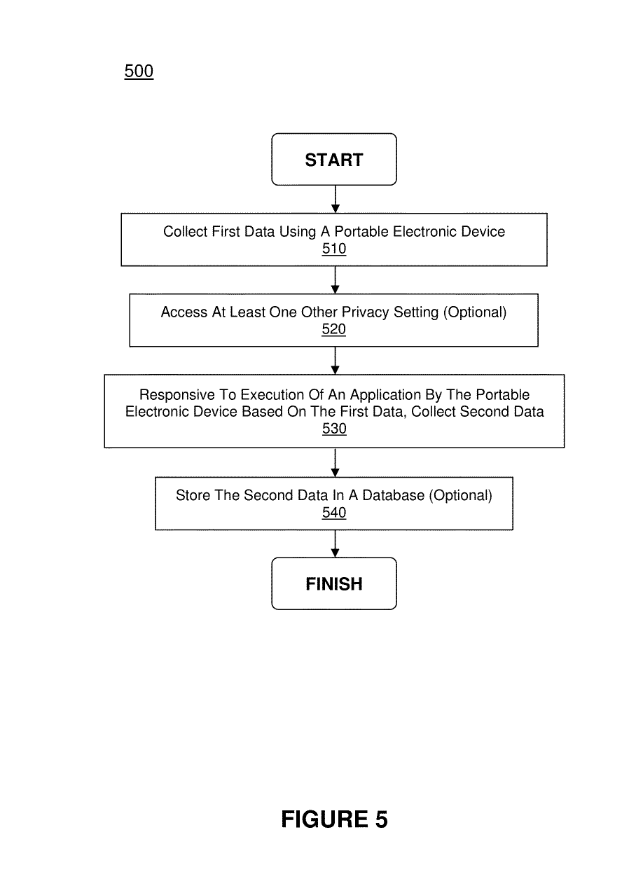

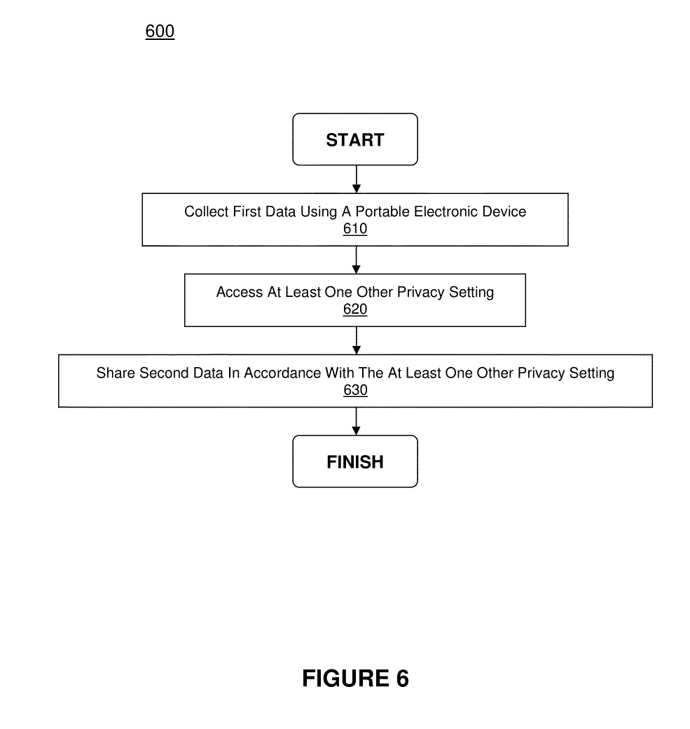

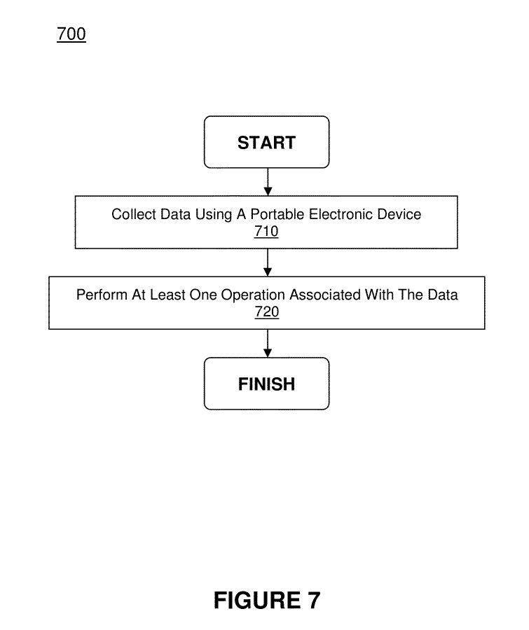

One or more steps of process 400 may be performed in conjunction with one or more steps of at least one other process in one embodiment. For example, one or more steps of process 400 may be performed in conjunction with one or more steps of process 500 of FIG. 5, process 600 of FIG. 6, process 700 of FIG. 7, some combination thereof, etc.

Although FIG. 4 depicts process 400 as including a specific number of steps, it should be appreciated that process 400 may include a different number of steps in other embodiments. Although FIG. 4 depicts process 400 as including a specific ordering of steps, it should be appreciated that process 400 may include a different ordering of steps in other embodiments.

FIG. 5 shows a flowchart of process 500 for collecting other data in accordance with one embodiment. As shown in FIG. 5, step 510 involves collecting data using a portable electronic device (e.g., 130a, 130b, 130c, etc.). Step 510 may involve collecting the data, in accordance with at least one privacy setting (e.g., 124a, 124b, 124c, etc.), responsive to execution of an application (e.g., 135a, 135b, 135c, etc.) by the portable electronic device (e.g., 130a, 130b, 130c, etc.) based on user data (e.g., 122a, 122b, 122c, etc.). In one embodiment, the data may be stored in step 510 in a database (e.g., 120). And in one embodiment, step 510 may involve collecting the data in accordance with one or more steps of process 300.

Step 520 involves optionally accessing at least one other privacy setting. The at least one other privacy setting (e.g., 124a, 124b, 124c, etc.) accessed in step 520 may be associated with collection of data in one embodiment.

The at least one other privacy setting (e.g., 124a, 124b, 124c, etc.) accessed in step 520 may be different from at least one privacy setting associated with collection of the first data (e.g., in step 510) in one embodiment. For example, where the at least one privacy setting associated with collection of the first data (e.g., in step 510) is related to at least one image taken of a product or a code (e.g., barcode, QR code, etc.) of a product, the at least one other privacy setting (e.g., accessed in step 520) may relate to collection of information associated with at least one interaction between a user and a portable electronic device responsive to application execution. And in one embodiment, step 520 may be performed similarly to access of at least one privacy setting in step 350 of process 300.

Step 520 may involve accessing at least one other privacy setting at computer system 110 in one embodiment. In one embodiment, step 520 may involve accessing at least one other privacy setting based on the identification data (e.g., accessed in step 310 of process 300). Step 520 may involve accessing at least one other privacy setting based on and/or corresponding to a user profile or account (e.g., determined in step 330 of process 300) in one embodiment. As such, in one embodiment, the at least one other privacy setting accessed in step 520 may correspond to the same user profile or account as the at least one privacy setting (e.g., accessed in step 510, accessed in step 350 of process 300, etc.) associated with collection of the first data (e.g., in step 510).

As shown in FIG. 5, step 530 involves collecting second data responsive to execution of an application (e.g., 135a, 135b, 135c, etc.) by the portable electronic device (e.g., 130a, 130b, 130c, etc.) based on the first data (e.g., collected in step 510). In one embodiment, where the first data is collected in step 510 responsive to execution of an application by the portable electronic device based on user data (e.g., 122a, 122b, 122c, etc.), the second data may be collected in step 530 responsive to execution of the same application by the portable electronic device based on the first data. In this case, execution of the same application based on different data (e.g., user data in step 510, first data in step 530, etc.) may result in an altered user experience, different application functionality, different gameplay, rendering of different content (e.g., at least one image, video, sounds, etc.), some combination thereof, etc.

In one embodiment, the first data and second data may be collected (e.g., in steps 510 and 530, respectively) in accordance with the same privacy setting or same privacy settings. Alternatively, the first data and second data may be collected (e.g., in steps 510 and 530, respectively) in accordance with at least one different privacy setting. For example, where the first data is collected in step 510 in accordance with at least one privacy setting, the second data may be collected in step 530 in accordance with at least one other privacy setting (e.g., accessed in step 520).

As shown in FIG. 5, step 540 involves storing the second data (e.g., collected in step 530) in a database (e.g., 120). The second data may be stored in the database (e.g., 120) as a portion of user data (e.g., 122a, 122b, 122c, etc.) in one embodiment. The second data stored in step 540 may be organized into and/or associated with user profiles or accounts (e.g., 126a, 126b, 126c, etc.), where each user profile or account may correspond to a respective portable electronic device (e.g., 130a, 130b, 130c, etc.), a respective user, a respective group of users (e.g., a family, co-workers, a group of friends, etc.), or some combination thereof. In one embodiment, step 540 may be performed by computer system 110, the portable electronic device (e.g., executing the application and/or used to collect the second data), some combination thereof, etc.

As an example related to retail shopping, first data may be collected (e.g., in step 510) associated with at least one image of a product or code (e.g., barcode, QR code, etc.) of a product. The first data may be collected responsive to execution of an application (e.g., 135a, 135b, 135c, etc.) by a portable electronic device (e.g., 130a, 130b, 130c, etc.), where the at least one image may be acquired using a camera or imaging component of the portable electronic device. The application may be tool or game related to retail shopping such as a tool that allows a user to view and/or modify a shopping list (e.g., check an item off the shopping list, add or remove at least one item from the shopping list, etc.), perform price comparisons related to one or more items, view additional information (e.g., nutritional information, historical information, price comparison information, etc.) about an item, some combination thereof, etc. The first data may be collected in accordance with at least one privacy setting (e.g., related to the user allowing the collection of images, or information associated therewith, acquired using the portable electronic device).

The application may be executed (e.g., by the portable electronic device) based on the first data to render content associated with a list of recipes that use the product (e.g., shown in the at least one image, corresponding to the product code shown in the at least one image, etc.). Responsive to execution of the application based on the first data, second data may be collected (e.g., in step 530) associated with a selection of a recipe from the list of recipes. The second data may be collected in accordance with at least one other privacy setting (e.g., accessed in step 520), where the at least one other privacy setting may be related to the user allowing collection of data associated with at least one interaction between the user and the portable electronic device. The second data may be optionally stored (e.g., as a portion of user data) in a database (e.g., in step 540).

In one embodiment, one or more steps of process 500 may be repeated to further refine or alter the user experience. For example, responsive to a user selection of a recipe from the list of recipes (e.g., associated with the second data collected in step 530), the application may be executed (e.g., by the portable electronic device) based on the second data to render content associated with a list of products used in the selected recipe. Responsive thereto, other data may be collected (e.g., in step 530) associated with a selection of a product from the list of products. The other data may be optionally stored (e.g., as a portion of user data) in a database (e.g., in step 540). In this manner, data collected responsive to application execution may be used to advantageously alter (e.g., dynamically, in real-time, on-the-fly, etc.) the user experience (e.g., to further customize or personalize the user experience, to otherwise alter application execution to allow the collection of other data, etc.), thereby allowing the collection of a larger amount of data, increasing the accuracy and/or precision of the data collection, some combination thereof, etc.

One or more steps of process 500 may be performed in conjunction with one or more steps of at least one other process in one embodiment. For example, one or more steps of process 500 may be performed in conjunction with one or more steps of process 400 of FIG. 4, process 600 of FIG. 6, process 700 of FIG. 7, some combination thereof, etc.

Although FIG. 5 depicts process 500 as including a specific number of steps, it should be appreciated that process 500 may include a different number of steps in other embodiments. Although FIG. 5 depicts process 500 as including a specific ordering of steps, it should be appreciated that process 500 may include a different ordering of steps in other embodiments.

FIG. 6 shows a flowchart of process 600 for sharing data in accordance with one embodiment. As shown in FIG. 6, step 610 involves collecting data using a portable electronic device (e.g., 130a, 130b, 130c, etc.). Step 610 may involve collecting the data, in accordance with at least one privacy setting (e.g., 124a, 124b, 124c, etc.), responsive to execution of an application (e.g., 135a, 135b, 135c, etc.) by the portable electronic device (e.g., 130a, 130b, 130c, etc.) based on user data (e.g., 122a, 122b, 122c, etc.). In one embodiment, the data may be stored in step 610 in a database (e.g., 120). And in one embodiment, step 610 may involve collecting the data in accordance with one or more steps of process 300.

Step 620 involves accessing at least one other privacy setting. The at least one other privacy setting (e.g., 124a, 124b, 124c, etc.) accessed in step 620 may be associated with sharing of data (e.g., user data, information supplied by a user, collected data, some combination thereof, etc.). As such, in one embodiment, the at least one other privacy setting accessed in step 620 may be different from at least one privacy setting (e.g., accessed in step 610, accessed in step 350 of process 300, etc.) associated with collection of the first data (e.g., in step 610).

Step 620 may involve accessing at least one other privacy setting at computer system 110 in one embodiment. In one embodiment, step 620 may be performed similarly to access of at least one privacy setting in step 350 of process 300. In one embodiment, step 620 may involve accessing at least one other privacy setting based on the identification data (e.g., accessed in step 310 of process 300). Step 620 may involve accessing at least one other privacy setting based on and/or corresponding to the user profile or account (e.g., determined in step 330 of process 300) in one embodiment. As such, in one embodiment, the at least one other privacy setting accessed in step 620 may correspond to the same user profile or account as the at least one privacy setting (e.g., accessed in step 610, accessed in step 350 of process 300, etc.) associated with collection of the first data (e.g., in step 610).

As shown in FIG. 6, step 630 involves sharing second data in accordance with the at least one other privacy setting. The second data may include at least a portion of user data (e.g., stored in database 120), at least a portion of data supplied by a user, at least a portion of the first data (e.g., collected in step 610), at least a portion of other collected data, some combination thereof, etc.

In one embodiment, step 630 may involve sharing the second data with a third party. For example, the second data may be shared in step 630 with at least one computer system (e.g., 140) that is associated with an entity, individual, etc. other than an entity, individual, etc. associated with computer system 110, portable electronic device 130a, portable electronic device 130b, portable electronic device 130c, etc. As another example, the second data may be shared in step 630 with a retailer, a consumer product goods manufacturer, another entity, etc.

One or more steps of process 600 may be used to implement a registration process in one embodiment. For example, registration data may be collected in step 610. At least one other privacy setting associated with sharing of the registration data (or at least a portion thereof) may be accessed in step 620. At least a portion of the registration data may be shared (e.g., with a manufacturer of the product, with an entity handling product registration for the manufacturer, etc.) in step 630.

Accordingly, embodiments may allow more efficient and/or secure registration of products. Efficiency may be improved by automating data collection and/or submission, thereby relieving the user of manually entering and/or submitting the information. For example, a portion of user data (e.g., 122a, 122b, 122c, etc.) that was previously supplied by a user may be automatically supplied to a product manufacturer for registration of a product. As another example, information about the product (e.g., model number, serial number, etc.) may be automatically collected using an image of the product, an image of a code of the product (e.g., a product-specific code providing or allowing automated determination of the model number, serial number, etc.), an image of text or other information on the product (e.g., the model number or serial number printed on the product packaging), etc.

In one embodiment, collection of registration data (e.g., in step 610) may be performed responsive to scanning or taking an image of a code of a product (e.g., using portable electronic device 130b, portable electronic device 130c, etc.). A user (e.g., of portable electronic device 130b, portable electronic device 130c, etc.) may be authenticated (e.g., in accordance with step 320 of process 300) responsive to the scanning or taking an image of a code of a product. And in one embodiment, the code of the product (e.g., used to initiate the registration process) may be a product-specific code that provides or allows automated determination of the model number of the product, serial number of the product, other information about the product, etc.

Security of the registration process may be improved by securely collecting, storing, and/or sharing the registration data with the product manufacturer. For example, registration data (e.g., stored in database 120) may be securely accessed (e.g., by computer system 110, portable electronic device 130a, portable electronic device 130b, portable electronic device 130c, etc.) and communicated to a product manufacturer (e.g., associated with computer system 140). As another example, authentication of a user (e.g., in step 320 of process 300) may further increase security of the registration process.

In one embodiment, one or more steps of process 600 may be performed in conjunction with one or more steps of at least one other process. For example, one or more steps of process 600 may be performed in conjunction with one or more steps of process 400 of FIG. 4, process 500 of FIG. 5, process 700 of FIG. 7, some combination thereof, etc.

Although FIG. 6 depicts process 600 as including a specific number of steps, it should be appreciated that process 600 may include a different number of steps in other embodiments. Although FIG. 6 depicts process 600 as including a specific ordering of steps, it should be appreciated that process 600 may include a different ordering of steps in other embodiments.

FIG. 7 shows a flowchart of process 700 for performing at least one operation in accordance with one embodiment. As shown in FIG. 7, step 710 involves collecting data using a portable electronic device (e.g., 130a, 130b, 130c, etc.). Step 710 may involve collecting the data, in accordance with at least one privacy setting (e.g., 124a, 124b, 124c, etc.), responsive to execution of an application (e.g., 135a, 135b, 135c, etc.) by the portable electronic device (e.g., 130a, 130b, 130c, etc.) based on user data (e.g., 122a, 122b, 122c, etc.). In one embodiment, the data may be stored in step 710 in a database (e.g., 120). And in one embodiment, step 710 may involve collecting the data in accordance with one or more steps of process 300.

Step 720 involves performing at least one operation associated with the data (e.g., collected in step 710). Step 720 may involve providing incentive data, providing advertisement data, performing processing to alter the application execution and/or user experience, providing at least one suggestion associated with at least one application to download, providing at least one communication encouraging the input of information, providing at least one communication encouraging the setting or modifying of at least one privacy setting, performing analysis based on the data collected in step 710, one or more other operations, etc.

Where step 720 involves providing incentive data, the incentive data may be associated with or provided based on the data collected in step 710. The incentive data may be associated with at least one incentive including at least one coupon, at least one discount, at least one point, at least one frequent flyer mile, cash back, some combination thereof, etc. In one embodiment, the incentive data may be associated with at least one incentive that is specific or unique to the user profile corresponding to the data collected in step 710. In one embodiment, the incentive data may include at least one image, video, audio, text, some combination thereof, etc.

As an example, if the data collected in step 710 indicates that a user prefers a certain brand of product, then incentive data associated with the brand of product may be communicated to the user (e.g., via the portable electronic device) in step 720. As another example, if the data collected in step 710 indicates that a user is in proximity to (e.g., within a predetermined distance from) a particular product (e.g., within a store), then incentive data associated with the product may be communicated to the user (e.g., via the portable electronic device while the user is still in proximity to the product) in step 720. The incentive data may be further customized or personalized for the user based on user data (e.g., 122a, 122b, 122c, etc.) such as age, gender, etc.

In one embodiment, the incentive data may be provided in step 720 by computer system 110. The incentive data may be accessed by computer system 110 from local memory (e.g., of computer system 110), database 120, database 150, computer system 140, some combination thereof, etc. In one embodiment, the incentive data may be provided by a third party (e.g., via computer system 140, database 150, etc.), where the third party may be (or be associated with) a consumer product goods manufacturer, a retailer, an independent incentive processing company, a website or online server providing incentive data, etc. And in one embodiment, the incentive data may be provided in step 720 via the portable electronic device used to collect the data in step 710.

Where step 720 involves providing advertisement data, the advertisement data may be associated with or provided based on the data collected in step 710. The advertisement data may include at least one image, video, audio, text, some combination thereof, etc.

As an example, if the data collected in step 710 indicates that a user prefers a certain brand of product, then advertisement data associated with the brand of product may be communicated to the user (e.g., via the portable electronic device) in step 720. As another example, if the data collected in step 710 indicates that a user is in proximity to (e.g., within a predetermined distance from) a particular product (e.g., within a store), then advertisement data associated with the product may be communicated to the user (e.g., via the portable electronic device while the user is still in proximity to the product) in step 720. The advertisement data may be further customized or personalized for the user based on user data (e.g., 122a, 122b, 122c, etc.) such as age, gender, etc.

In one embodiment, the advertisement data may be provided in step 720 by computer system 110. The advertisement data may be accessed by computer system 110 from local memory (e.g., of computer system 110), database 120, database 150, computer system 140, some combination thereof, etc. In one embodiment, the advertisement data may be provided by a third party (e.g., via computer system 140, database 150, etc.), where the third party may be (or be associated with) a consumer product goods manufacturer, a retailer, an independent advertisement processing company, a website or online server providing advertisement data, etc. And in one embodiment, the advertisement data may be provided in step 720 via the portable electronic device used to collect the data in step 710.

Where step 720 involves performing processing to alter the application execution and/or user experience, the processing may be associated with or performed based on the data collected in step 710. For example, if the data collected in step 710 is associated with a particular product (e.g., an image of the product, an image of a code of the product, a user selection of the product, user-supplied data associated with the product, etc.), then information associated with the product may be determined and/or accessed (e.g., in step 720). The information may include nutritional information, historical information, price comparison information (e.g., versus another similar product, etc.), other information, etc. The information may be presented (e.g., in step 720) via the portable electronic device responsive to execution of an application (e.g., also used to collect the data in step 710), thereby altering the application execution and/or user experience.

As another example, where the data collected in step 710 is associated with a product or item (e.g., an image of the item or code of the item, a user selection of the product or item, information associated with a user's location or proximity to the product or item, etc.), it may be determined (e.g., in step 720) whether or not the product or item is on the user's shopping list (e.g., rendered or accessed by the application, part of user data on which application execution is based, some combination thereof, etc.). If the product or item is not on the shopping list, then a message may be communicated (e.g., in step 720 via the portable electronic device executing the application, via the application, etc.) asking whether the product or item should be added to the shopping list. Presentation of the shopping list may be updated (e.g., in step 720) to include the selected product or item responsive to a user interaction indicating that the product or item should be added to the shopping list (e.g., where the user interaction is associated with or included in data collected in step 710). Alternatively, if the product or item is on the shopping list, then presentation of the shopping list may be updated (e.g., in step 720) to show that the item has been automatically checked off the shopping list (e.g., by displaying an identifier of the item with strikethrough, by displaying an identifier of the item in a color that is different from another color used to identify one or more items that have not yet been checked off the shopping list and/or added to the physical shopping cart, etc.). And in one embodiment, if the product or item is on the shopping list, then a message may be communicated (e.g., in step 720 via the portable electronic device executing the application, via the application, etc.) asking whether the product or item should be checked off the shopping list. Accordingly, the application execution and/or user experience may be altered.

As yet another example, where the data collected in step 710 includes or is associated with a user selection of a recipe from a list of recipes (e.g., similar to collection of second data as described with respect to step 530 of process 500), information associated with one or more other products or ingredients used in the recipe may be determined and/or accessed (e.g., in step 720). This information may be compared and/or processed with other data (e.g., associated with at least one item on a shopping list supplied by a user and/or rendered or accessed by the application, at least one item that the user is likely to have on hand at home, some combination thereof, etc.) to determine (e.g., in step 720) at least one item (e.g., that is used in the selected recipe and not on the shopping list, that is used in the recipe and not likely to be had at home, some combination thereof, etc.). Presentation of the shopping list (e.g., by the portable electronic device executing the application) may be updated (e.g., in step 720) to include the at least one item (e.g., automatically or responsive to a user interaction indicating that the at least one item should be added to the shopping list), thereby altering the application execution and/or user experience.

Where step 720 involves providing at least one suggestion associated with at least one application to download, the at least one suggestion may be associated with or provided based on the data collected in step 710 and/or other data (e.g., user data supplied by a user, other collected data, some combination thereof, etc.). For example, if the data collected in step 710 indicates that a user is in proximity to (e.g., within a predetermined distance from) or within a particular store, then a suggestion for the user to download an application corresponding to the store may be communicated to the user (e.g., while the user is still within or in proximity to the store) in step 720. Where the at least one suggestion is provided (e.g., in step 720) responsive to execution of and/or via an application (e.g., 135a, 135b, 135c, etc.), the at least one suggestion may include at least one suggestion to download at least one other application in one embodiment.

In one embodiment, one or more suggestions to download at least one application may be customized or personalized for the user based on user data (e.g., 122a, 122b, 122c, etc.) such as age, gender, etc. For example, where user data indicates that there are four girls under the age of 13 in a family (e.g., corresponding to a user profile associated with the user data) and the family is concerned with nutrition and drinks a significant amount of milk (e.g., as determined based on user data supplied by one or more family members, based on the type and/or brands of products purchased by the family, etc.), at least one suggestion may be provided (e.g., in step 720) to download at least one application (e.g., at least one game, at least one tool, etc.) relevant or tailored to teenage girls. The application may include or be configured to present, as an example, information about the benefits to teenage girls of drinking milk free of rBHT.

As another example, where user data indicates that there are four girls under the age of 13 in a family (e.g., corresponding to a user profile associated with user data) and the family is on a tight budget and the girls are trendy (e.g., as determined based on user data supplied by one or more family members, based on the type and/or brands of products purchased by the family, etc.), at least one suggestion may be provided (e.g., in step 720) to download at least one application (e.g., at least one game, at least one tool, etc.) relevant or tailored to teenage girls. The application may include or be configured to present, as an example, information about the latest teenage fashions (e.g., what is currently popular, what is not currently popular, etc.), where to purchase fashionable clothes on a budget, etc.

Where step 720 involves providing at least one communication encouraging the input of information, the at least one communication may be associated with or provided based on the data collected in step 710. For example, if the data collected in step 710 is associated with a particular piece of clothing or outfit, then at least one communication may be communicated (e.g., in step 720 via the portable electronic device executing the application, via the application, etc.) to encourage the user to enter user data associated with physical measurements (e.g., so that this information may be used to alter subsequent application execution and enhance the user experience where the application is associated with clothes shopping). As another example, if the data collected in step 710 is associated with a type of product that varies significantly based on the user's age, then at least one communication may be communicated (e.g., in step 720 via the portable electronic device executing the application, via the application, etc.) to encourage the user to enter user data associated with age (e.g., so that subsequent application execution can be personalized and customized based on the user's age to enhance the user experience). As yet another example, if the data collected in step 710 includes registration data, then at least one communication may be communicated (e.g., in step 720 via the portable electronic device executing the application, via the application, etc.) to encourage the user to enter other registration data (e.g., required for registration of a product and not previously entered by the user).

Where step 720 involves providing at least one communication encouraging the setting or modifying of at least one privacy setting, the at least one communication may be associated or provided based on with the data collected in step 710. For example, if the data collected in step 710 is associated with a particular product that corresponds to an incentive offered in exchange for data (e.g., a portion of user data, data collected in step 710, etc.), then at least one communication may be communicated (e.g., in step 720 via the portable electronic device executing the application, via the application, etc.) to encourage the user to set or modify at least one privacy setting to allow increased data collection and/or data sharing (e.g., so that the user can take advantage of the incentive). As another example, if the data collected in step 710 indicates that the user experience associated with an application could be enhanced by collecting other data (e.g., the location of the portable electronic device, whether the portable electronic device is in proximity to a product in a store, etc.), then at least one communication may be communicated (e.g., in step 720 via the portable electronic device executing the application, via the application, etc.) to encourage the user to set or modify at least one privacy setting to allow collection of data associated with the location of the portable electronic device, whether the portable electronic device is in proximity to a product in a store, etc. As yet another example, if the data collected in step 710 includes registration data, then at least one communication may be communicated (e.g., in step 720 via the portable electronic device executing the application, via the application, etc.) to encourage the user to set or modify at least one privacy setting to allow sharing (e.g., with a product manufacturer) of registration data (e.g., required for registration of a product, newly-collected registration data, newly-entered registration data, etc.).

Where step 720 involves performing analysis based on the data collected in step 710, the analysis may be performed based on the data alone or in conjunction with other data (e.g., user data 122a, user data 122b, user data 122c, etc.). For example, where the data collected in step 710 is associated with one or more organic products, the data may be analyzed (e.g., in step 720) to determine that one or more users (e.g., associated with a user profile) prefer organic products over non-organic products. The results of the analysis may be used to suggest one or more other products (e.g., organic products) for the user. As another example, where the data collected in step 710 is associated with one or more organic products (e.g., scanned or photographed by a user, viewed by a user, purchased by a user, etc.), the collected data may be analyzed (e.g., in step 720) in conjunction with other data (e.g., user data indicating that non-organic milk is routinely purchased by the user) to determine a particular product (e.g., organic milk) that may be interest to the user and/or may likely be purchased by the user. As yet another example, data collected in step 710 may be analyzed (e.g., either alone or in conjunction with other data) in step 720 across multiple user profiles to determine trends (e.g., men in their 30's prefer organic milk to non-organic milk, teenage girls in California prefer jeans to skirts, etc.). Accordingly, analysis performed (e.g., in step 720) based on collected data (e.g. collected in step 710) can provide increased customer insight.

As a further example, where data is collected about a user (e.g., in step 710), analysis may be performed (e.g., in step 720) by combining the collected data with loyalty card data to provide more information about a customer. As another example, analysis may be performed (e.g., in step 720) using the loyalty card data and other data (e.g., user data, data collected in step 720, some combination thereof, etc.) to determine other information such as purchasing trends or behaviors for a single customer (e.g., with one or more attributes determined based on or identified by user data), purchasing trends or behaviors across multiple customers (e.g., with one or more attributes determined based on or identified by user data), other data, etc.

One or more steps of process 700 may be performed in conjunction with one or more steps of at least one other process in one embodiment. For example, one or more steps of process 700 may be performed in conjunction with one or more steps of process 400 of FIG. 4, process 500 of FIG. 5, process 600 of FIG. 6, some combination thereof, etc.

Although FIG. 7 depicts process 700 as including a specific number of steps, it should be appreciated that process 700 may include a different number of steps in other embodiments. Although FIG. 7 depicts process 700 as including a specific ordering of steps, it should be appreciated that process 700 may include a different ordering of steps in other embodiments.

Although FIG. 1 shows system 100 with a specific number and type of systems or devices, it should be appreciated that system 100 may include a different number and/or type of systems or devices in other embodiments. For example, system 100 may include a larger or smaller number of portable electronic devices (e.g., 130a, 130b, 130c, etc.) in other embodiments. As another example, system 100 may include a larger or smaller number of databases (e.g., 120, 150, etc.) in other embodiments. And as yet another example, system 100 may include a larger or smaller number of computer systems (e.g., 110, 140, etc.) in other embodiments.

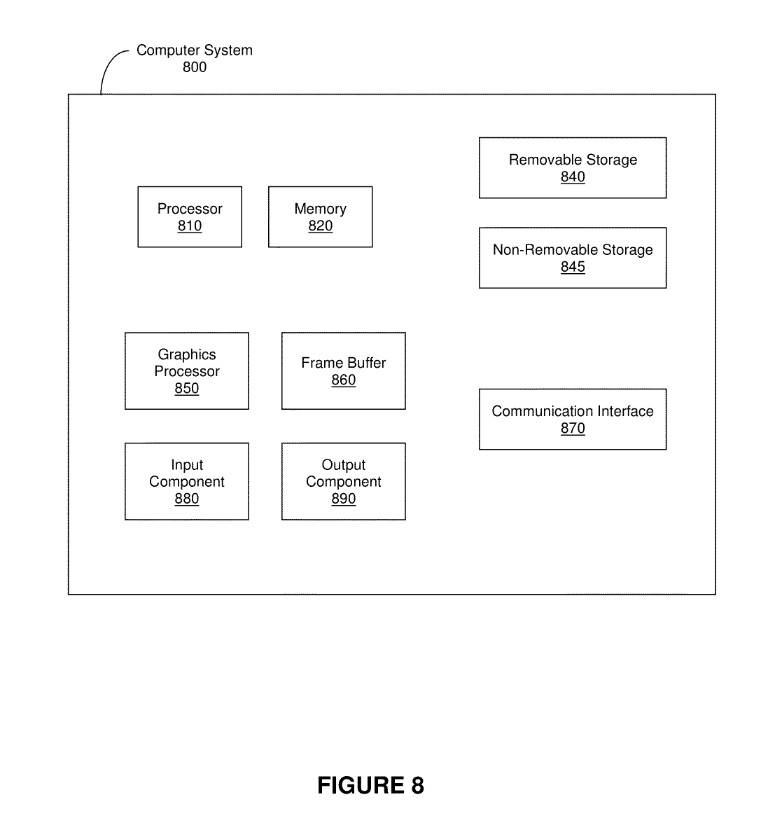

FIG. 8 shows computer system 800 upon which one or more embodiments may be implemented. As shown in FIG. 8, computer system 800 may include processor 810, memory 820, removable storage 840, non-removable storage 845, graphics processor 850, frame buffer 860, communication interface 870, input component 880, and output component 890. One or more embodiments may be implemented by execution of computer-readable instructions or computer-executable instructions that may reside in at least one component of computer system 800. In one embodiment, computer system 800 may be a general-purpose computer system, an embedded computer system, a laptop computer system, a hand-held computer system, a portable computer system and/or portable electronic device, a wearable device or wearable computer system, a stand-alone computer system, a server, etc.

In one embodiment, computer system 800 may be used to implement computer system 110, computer system 140, portable electronic device 130a, portable electronic device 130b, portable electronic device 130c, another system or device, some combination thereof, etc. And in one embodiment, one or more components of computer system 800 may be disposed in and/or coupled with a housing or enclosure.

In one embodiment, processor 810 may be or include a central processing unit (CPU) or other type of processor. Depending on the configuration and/or type of computer system environment, memory 820 may be or include volatile memory (e.g., RAM), non-volatile memory (e.g., ROM, flash memory, etc.), some combination thereof, etc. In one embodiment, memory 820 may be removable. Alternatively, memory 820 may be non-removable.

In one embodiment, computer system 800 may include additional storage (e.g., removable storage 840, non-removable storage 845, etc.). Removable storage 840 and/or non-removable storage 845 may include volatile memory, non-volatile memory, some combination thereof, etc. In one embodiment, removable storage 840 and/or non-removable storage 845 may include at least one medium and/or components (e.g., including hardware and/or software) configured to access data stored on the at least one medium, where the at least one medium may include at least one optical storage medium (e.g., CD-ROM, DVD, Blu-ray, etc.), at least one magnetic cassette, at least one magnetic tape, at least one magnetic disk storage, at least one other magnetic storage device, or any other medium which can be used to store information for access by one or more components of computer system 800.

As shown in FIG. 8, computer system 800 may communicate with other systems, components, or devices via communication interface 870. In one embodiment, communication interface 870 may embody computer-readable instructions, data structures, program modules or other data in a modulated data signal (e.g., a carrier wave) or other transport mechanism. By way of example and not limitation, communication interface 870 may couple to and/or communicate over at least one wired medium (e.g., a wired network, direct-wired connection, etc.) and/or at least one wireless medium (e.g., a wireless network, a wireless connection utilizing acoustic, RF, infrared, or other wireless signaling, etc.).

Communication interface 870 may couple computer system 800 to one or more external input components (e.g., a keyboard, a mouse, a trackball, a joystick, a pen, a voice input device, a touch input device, a camera, a scanner, a wired peripheral device, a wireless peripheral device, etc.) in one embodiment. In one embodiment, communication interface 870 may couple computer system 800 to one or more external output components (e.g., a display, a speaker, a printer, etc.). And in one embodiment, communication interface 870 may include a plug, receptacle, cable, slot, wireless receiver, wireless transmitter, or any other component configured to couple to and/or communicate with another component, device, system, etc.

Input component 880 may include any component capable of receiving or allowing the input of information. For example, input component 880 may be or include a keyboard, at least one button or key, a mouse, a trackball, a joystick, a pen, a voice input device, a touch input device, a camera, an accelerometer, a gyrometer, a GPS receiver, a heart rate monitor, a fingerprint sensor, a proximity sensor, a barometer, a hall effect sensor, an ambient light sensor, a gesture sensor, another type of input component, etc. Output component 890 may include any component capable of transmitting or allowing the output of information. For example, output component 890 may be or include at least one display, at least one speaker, a printer, another type of output component, etc.

As shown in FIG. 8, graphics processor 850 may perform graphics processing operations on graphical data stored in frame buffer 860 or another memory (e.g., 820, 840, 845, etc.) of computer system 800. Graphical data stored in frame buffer 860 may be accessed, processed, and/or modified by components (e.g., graphics processor 850, processor 810, some combination thereof, etc.) of computer system 800 and/or components of other systems, other devices, etc. And in one embodiment, the graphical data may be accessed (e.g., by graphics processor 850) and displayed using an output component (e.g., 890) and/or an output device coupled to computer system 800.

In one embodiment, a memory of computer system 800 (e.g., memory 820, removable storage 840, non-removable storage 845, frame buffer 860, some combination thereof, etc.) may be a computer-readable medium (or computer-usable medium, or computer-readable storage medium, etc.) and may include instructions that when executed by a processor (e.g., 810, 850, etc.) implement a method of collecting data (e.g., in accordance with process 300 of FIG. 3), creating a user profile or account (e.g., in accordance with process 400 of FIG. 4), collecting other data (e.g., in accordance with process 500 of FIG. 5), sharing data (e.g., in accordance with process 600 of FIG. 6), performing at least one operation (e.g., in accordance with process 700 of FIG. 7), some combination thereof, etc. And in one embodiment, a computer-readable medium of computer system 800 may be implemented in and/or using at least one die of at least one integrated circuit (e.g., at least one application-specific integrated circuit (ASIC), at least one system-on-a-chip (SOC), at least one programmable system-on-a-chip (PSOC), another type of integrated circuit, etc.).

In the foregoing specification, embodiments have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction or amendment thereto. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A method comprising:
accessing user data corresponding to a user profile;
accessing at least one privacy setting corresponding to said user profile; and
responsive to execution of an application by a portable electronic device based on said user data, collecting data via said portable electronic device in accordance with said at least one privacy setting.

2. The method of claim 1, wherein said user data is selected from a group consisting of at least one age, at least one gender, at least one image of a user associated with said user profile, at least one fiscal budget, a frequency of past shopping trips, at least one brand preference, information corresponding to at least one shopping list item, information corresponding to at least one purchased item, information corresponding to at least one product, at least one physical measurement of a user associated with said user profile, an image of an item, information associated with an image of an item, an image of an item code, information associated with an image of an item code, and registration data.

3. The method of claim 1, wherein said data is selected from a group consisting of at least one location of said portable electronic device, at least one image taken using said portable electronic device, information associated with at least one image taken using said portable electronic device, and an interaction between a user and said portable electronic device responsive to execution of said application.

4. The method of claim 3, wherein said at least one location is selected from a group consisting of at least one absolute location of said portable electronic device, at least one relative location of said portable electronic device with respect to a store, at least one relative location of said portable electronic device with respect to a region of a store, and at least one relative location of said portable electronic device with respect to an item in a store.

5. The method of claim 3, wherein said collecting data further includes determining said at least one location via communication between said portable electronic device and at least one component selected from a group consisting of at least one beacon, at least one radio-frequency identification (RFID) tag, Wi-Fi components allowing Wi-Fi triangulation, and at least one component allowing near field communication (NFC).

6. The method of claim 1 further comprising:
accessing, via said portable electronic device, identification data corresponding to said user profile, and
wherein said accessing said user data further includes accessing said user data based on said identification data,
wherein said accessing said at least one privacy setting further includes accessing said at least one privacy setting based on said identification data, and
wherein said identification data is selected from a group consisting of: a name; an email address; a password; an authorization code from a computer system performing authentication of a user associated with said user profile; and a token from a computer system performing authentication of a user associated with said user profile.

7. The method of claim 1 further comprising:
accessing at least one other privacy setting corresponding to said user profile; and
responsive to execution of said application by said portable electronic device based on said data, collecting other data via said portable electronic device in accordance with said at least one other privacy setting.

8. The method of claim 1 further comprising:
accessing at least one other privacy setting corresponding to said user profile; and
sharing second data with a computer system in accordance with said at least one other privacy setting, wherein said computer system is separate from said portable electronic device, and wherein said second data is selected from a group consisting of: at least a portion of said user data; and at least a portion of said data.

9. The method of claim 1 further comprising:
responsive to collection of said data, performing at least one operation, wherein said at least one operation is selected from a group consisting of: providing, via said portable electronic device, incentive data; providing, via said portable electronic device, advertisement data; performing processing to alter said execution of said application; providing at least one suggestion associated with at least one other application to download; providing at least one communication encouraging input of other user data; providing at least one communication encouraging a setting of at least one other privacy setting; providing at least one communication encouraging a modification of said at least one privacy setting; and performing analysis based on said data.

10. A system comprising:
a database configured to store first data corresponding to a plurality of user profiles, wherein said first data includes user data corresponding to a user profile of said plurality of user profiles, and wherein said first data includes at least one privacy setting corresponding to said user profile; and
a computer system configured to access, from said database, said user data and said at least one privacy setting, wherein said computer system is further configured to collect, responsive to execution of an application by a portable electronic device based on said user data, second data via said portable electronic device in accordance with said at least one privacy setting, and wherein said computer system is separate from said portable electronic device.

11. The system of claim 10 further comprising:
said portable electronic device.

12. The system of claim 10, wherein said user data is selected from a group consisting of at least one age, at least one gender, at least one image of a user associated with said user profile, at least one fiscal budget, a frequency of past shopping trips, at least one brand preference, information corresponding to at least one shopping list item, information corresponding to at least one purchased item, information corresponding to at least one product, at least one physical measurement of a user associated with said user profile, an image of an item, information associated with an image of an item, an image of an item code, information associated with an image of an item code, and registration data.

13. The system of claim 10, wherein said second data is selected from a group consisting of at least one location of said portable electronic device, at least one image taken using said portable electronic device, information associated with at least one image taken using said portable electronic device, and an interaction between a user and said portable electronic device responsive to execution of said application.

14. The system of claim 13, wherein said at least one location is selected from a group consisting of at least one absolute location of said portable electronic device, at least one relative location of said portable electronic device with respect to a store, at least one relative location of said portable electronic device with respect to a region of a store, and at least one relative location of said portable electronic device with respect to an item in a store.

15. The system of claim 13, wherein said at least one location is determined via communication with at least one component selected from a group consisting of at least one beacon, at least one radio-frequency identification (RFID) tag, Wi-Fi components allowing Wi-Fi triangulation, and at least one component allowing near field communication (NFC).

16. The system of claim 10, wherein said computer system is configured to access, via said portable electronic device, identification data corresponding to said user profile, wherein said computer system is further configured to access said user data based on said identification data, and wherein said computer system is further configured to access said at least one privacy setting based on said identification data, and
wherein said identification data is selected from a group consisting of: a name; an email address; a password; an authorization code from another computer system performing authentication of a user associated with said user profile; and a token from another computer system performing authentication of a user associated with said user profile.

17. The system of claim 10, wherein said computer system is configured to access at least one other privacy setting corresponding to said user profile, and wherein said computer system is further configured to collect, responsive to execution of said application by said portable electronic device based on said second data, other data via said portable electronic device in accordance with said at least one other privacy setting.

18. The system of claim 10, wherein said computer system is configured to access at least one other privacy setting corresponding to said user profile, wherein said computer system is configured to share third data with another computer system in accordance with said at least one other privacy setting, wherein said another computer system is separate from said portable electronic device, and wherein said third data is selected from a group consisting of: at least a portion of said user data; and at least a portion of said second data.

19. The system of claim 10, wherein said computer system is configured to perform, responsive to collection of said second data, at least one operation, wherein said at least one operation is selected from a group consisting of: providing, via said portable electronic device, incentive data; providing, via said portable electronic device, advertisement data; performing processing to alter said execution of said application; providing at least one suggestion associated with at least one other application to download; providing at least one communication encouraging input of other user data; providing at least one communication encouraging a setting of at least one other privacy setting; providing at least one communication encouraging a modification of said at least one privacy setting; and performing analysis based on said second data.

20. A system comprising:
means for accessing user data corresponding to a user profile;
means for accessing at least one privacy setting corresponding to said user profile; and
means for collecting, responsive to execution of an application by a portable electronic device based on said user data, data via said portable electronic device in accordance with said at least one privacy setting.
